(19) United States
(12) Patent Application Publication
(10) Pub. No.: US 2009/0177683 A1
(43) Pub. Date: Jul. 9, 2009

(54) MULTIMEDIA FILE CO-PROCESSING SYSTEM AND METHOD

(75) Inventors: Yu-Zhang Wen, Shenzhen City (CN); Zai-An Pan, Shenzhen City (CN); Shih-Fang Wong, Tu-Cheng (TW)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/206,724

(22) Filed: Sep. 8, 2008

(30) Foreign Application Priority Data
Jan. 7, 2008 (CN) 200810300040.2

(51) Int. Cl. G06F 7/00; G06F 17/30

(52) U.S. Cl. 707/102; 707/E17.005

(57) ABSTRACT

A mobile electronic system for sharing a multimedia playlist over a communication network to a receiving mobile electronic device is disclosed. The system generates a co-processing request according to operations of the user via an input unit and sends the co-processing request to the sharing mobile electronic device. The system may receive a proposing playlist listing multimedia files to be shared with the sharing mobile electronic device and determines if one or more multimedia files listed in the proposing playlist exist in the data storage of the sharing mobile electronic device. The system generates a matching playlist according to the determined multimedia files, sends the matching playlist to the sharing mobile electronic device, and plays the multimedia files listed in the matching playlist.

### BACKGROUND

1. Field of the Invention

Embodiments of the present disclosure relate to sharing multimedia files, and more particularly to a system and method for sharing a multimedia playlist over a communication network.

2. Description of Related Art

Many electronic devices, such as cell phone, personal digital assistant (PDA), or computer may communicate with each other and play multimedia files, such as audio and video files. These multimedia files may be shared among other electronic files to be played synchronously. In one such method, a first communication device can request multimedia files to be played synchronously by a second communication device. The selected multimedia files are transmitted to a digital-to-analog converter (DAC) in order to convert the multimedia files into an analog signal, and then output the analog signal to an audio output device. Additionally, the selected multimedia files are mixed with a speech signal transmitted from an audio input device, such as microphone. The mixed signal is transmitted to the second communication device.

In the above mentioned method, in order to share the same multimedia file, the first communication device must first mix the speech signal transmitted from the audio input device with the multimedia file, and then transmit the mixed signal to the second communication device to output. Unfortunately, the process increases a load of the network between the first communication device and the second device, and the process furthermore requires a rapid transmitting speed and a stable network.

Therefore, what is needed is a multimedia file co-processing system and method to amend the aforementioned problems.

### SUMMARY

A multimedia file co-processing method for a sending mobile electronic device adapted to communicate with a receiving mobile electronic device over a communication network is provided. The method includes: generating a co-processing request according to operations of a user; sending the co-processing request to the receiving mobile electronic device; receiving the co-processing request transmitted from the sending mobile electronic device; selecting multimedia files to be played synchronously between the sending mobile electronic device and the receiving mobile electronic device, and generating a proposing playlist according to the selected multimedia files; sending the proposing playlist to the receiving mobile electronic device; receiving the proposing playlist from the receiving mobile electronic device; determining if the multimedia files listed in the proposing playlist exist in the sending mobile electronic device ; generating a matching playlist according to determined multimedia files upon the condition that multimedia files listed in the proposing playlist exist in the sending mobile electronic device ; sending the matching playlist to the receiving mobile electronic device ; receiving the matching playlist transmitted from the sending mobile electronic device and saving the matching playlist as a co-processing playlist; reading multimedia files listed in the co-processing playlist from the receiving mobile electronic device to play; and reading multimedia files listed in the matching playlist from the sending mobile electronic device to play.

Other advantages and novel features will be drawn from the following detailed description of the preferred embodiment with reference to the attached drawings.

### BRIEF DESCRIPTION OF THE DRAWINGS

The components of the drawings are not necessarily drawn to scale, the emphasis instead being placed upon clearly illustrating the principles of the multimedia files co-processing system. Moreover, in the drawings, like reference numerals designate corresponding parts throughout several views.

FIG. 1 is an architectural diagram of one embodiment of a multimedia file co-processing system of the present disclosure.

FIG. 2 is a block diagram of one embodiment of main function modules of a sending party.

FIG. 3 is a block diagram of one embodiment of main function modules of a receiving party.

FIG. 4 is a flowchart of one embodiment of a multimedia file co-processing method.

### DETAILED DESCRIPTION OF CERTAIN INVENTIVE EMBODIMENTS

As used herein, the term, “multimedia files” or “multimedia file” refer to electronic audio and video files. It may be understood that a multimedia file may include a playlist listing one or more multimedia files to be executed/played by an electronic device. Furthermore, the multimedia file includes metadata, such as an artist name, an album name, and a file address, for example.

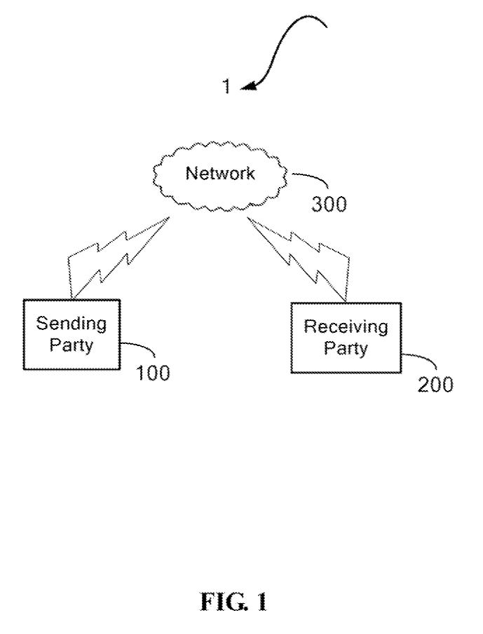

FIG. 1 is an architectural diagram of one embodiment of a multimedia file co-processing system 1 of the present disclosure. The system 1 includes a sending party 100 and a receiving party 200 communicating over a network 300. The sending party 100 and the receiving party 200 may share a same playlist between the two parties 100, 200 in order to play one or more multimedia files, such as a song file, existing on both of the two parties 100, 200. In one embodiment, the sending party 100 and the receiving party 200 may be any electronic device with a multimedia playing function and a vocal communication function, such as a personal digital assistant (PDA), a cellphone, or a computer, for example. The network 300 can be the Internet or a wireless network such as a general packet radio service (GPRS).

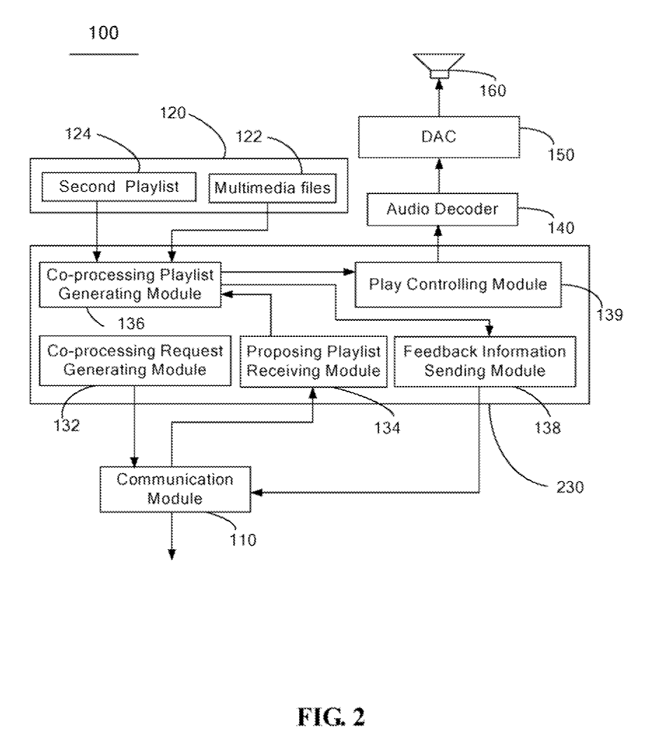

FIG. 2 is a block diagram of one embodiment of the sending party 100 including various function modules. The sending party 100 includes a data storage 120 configured for storing a plurality of multimedia files 122 and a first playlist 123. The first playlist 123 records any metadata of the multimedia files 122 and stores the metadata in a tabular form, in one embodiment, such as in Table 1. For example, in reference to Table 1, a first row shows “AA” as a multimedia file title, “John” as an artist name of the multimedia file, “A” as an album name of the multimedia file, and “XXXXXXX1” as a file address (e.g., Desktop/Username/Music/My_life.mp3, for example) of the multimedia files 122. The data storage 120 may be a hard disk drive, a flash drive, for example.

TABLE 1

| Multimedia file title | Artist name | Album name | File address |
|---|---|---|---|
| AA | John | A | XXXXXXX1 |
| BB | Rose | B | XXXXXXX2 |
| EE | Cat | C | XXXXXXX3 |
| FF | Stone | D | XXXXXXX4 |

The sending party 100 further includes a processing unit 130. The processing unit 130 includes a co-process request generating module 132, a proposing playlist receiving module 134, a co-processing playlist generating module 136, a feedback information sending module 138, and a play controlling module 139.

The co-processing request generating module 132 is configured for generating a co-processing request according to operations of the user via an input unit 140 and sending the co-processing request to the receiving party 200.

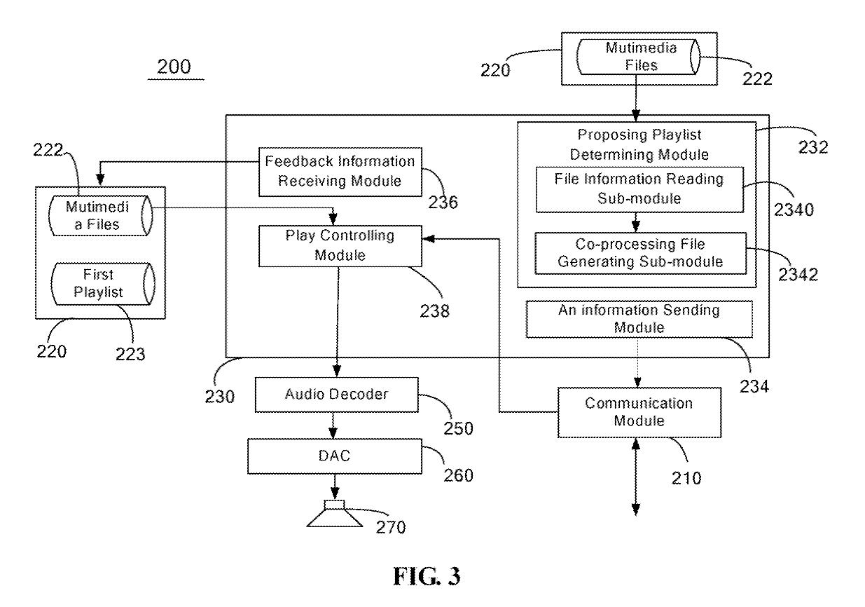

The proposing playlist receiving module 134 is configured for receiving a proposing playlist from the receiving party 200 through a communication module 110. The proposing playlist lists one or more multimedia files which have to be played synchronously between the sending party 100 and the receiving party 200, and is generated by the receiving party 200 when the receiving party 200 receives the co-processing request. A detailed description on generating the proposing playlist will be described in FIG. 3.

The co-processing playlist generating module 136 is configured for determining if the multimedia files listed in the proposing playlist exist in the data storage 120 according to the metadata recorded in the proposing playlist and the first playlist 124, and generates a feedback information signal according the determined result. If none of the multimedia files listed in the proposing playlist exist in the data storage 120, the playlist determining module 138 generates the feedback information signal to the sending party 100. If one or more multimedia files exist in the data storage 220 according to the metadata in the proposing playlists, then the playlist determining module 134 generates a matching playlist according to the determined multimedia files. For example, if the proposing playlist lists the multimedia files AA, BB, and CC, and only multimedia files AA and CC exist in the data storage 120 of the sending party 100, the co-processing playlist generating module 136 lists multimedia files AA and CC to generate the matching playlist. The feedback information sending module 136 is for sending the feedback information to the sending party 100. The play controlling module 139 is configured for reading the multimedia files listed in the matching playlist from the data storage 120 according to the file address recorded in the matching playlist, and sending the read multimedia files to an audio decoder 150 of the sending party 100 to decode the multimedia files 122 to digital audio information. The decoded digital audio information is transmitted to a digital-to-analog converter (DAC) 160 of the sending party 100 to convert the decoded digital information into analog information. The converted analog information is transmitted to the audio output device 170 to output audio signals.

FIG. 3 is a block diagram of one embodiment of main function modules of the receiving party 200. The receiving party 200 includes a data storage 220 for storing a second playlist 224 and a plurality of multimedia files 222. The second playlist 224 records the same metadata of the multimedia files 222 as the first playlist 124, such as in Table 2. The data storage 220 may be a hard disk drive, a flash drive, for example. The receiving party 200 further includes a processing unit 230. The processing unit 230 includes a proposing playlist determining module 232, an information sending module 234, a feedback information receiving module 236, and a play controlling module 238.

TABLE 2

| Multimedia file | | | |
|---|---|---|---|
| title | Artist name | Album name | File address |
| AA | John | A | XXXXXXX1 |
| BB | Rose | B | XXXXXXX2 |
| CC | Cat | C | XXXXXXX3 |
| DD | Stone | D | XXXXXXX4 |

The proposing playlist determining module 232 is configured for receiving the co-processing request transmitted from the sending party 100, and determining which of the multimedia files 222 need to be synchronously played between the sending party 100 and the receiving party 200 after the co-processing request is received. The proposing playlist generating module 232 includes a file information reading sub-module 2320, a co-process file selection sub-module 2322, and a proposing playlist generating sub-module 2324.

The file information reading sub-module 2320 is configured for reading the second playlist 223 from the data storage 220, and displaying the second playlist 223 on a display (not shown) of the receiving party 200.

The co-process file selection sub-module 2322 is configured for selecting multimedia files which have to be played synchronously between the two parties 100, 200 from the second playlist 223 according to selection inputs corresponding to the second playlist 223. For example, in reference to Table 2, multimedia files AA, BB, and CC in the second playlist 223 may be selected as multimedia files which have to be played synchronously between the two parties 100, 200. The selected multimedia files form a proposing playlist.

The information sending module 234 is configured for sending the proposing playlist to the sending party 100. After receiving the proposing playlist, the sending party 100 generates the feedback information according to the proposing playlist and sends the feedback information to the receiving party 200. The feedback information may be a matching playlist or a feedback signal.

The feedback information receiving module 236 is configured for receiving the feedback information from the sending party 100.

The feedback information receiving module 236 notifies the proposing playlist generating module 134 to generate a new proposing playlist if the feedback signal which represents that none of multimedia files listed in the proposing list exists in the sending party 200 is received.

The feedback information receiving module 236 stores the matching playlist to the data storage 220 as a co-processing playlist and updates the file address of each multimedia files listed in the co-processing playlist if the matching playlist is received. The play controlling module 238 is for reading the multimedia files 222 listed in the co-processing playlist from the data storage 220 orderly according to the file address recorded in the co-processing playlist and sending the multimedia files to an audio decoder 250 to decode to digital audio information. The digital audio information is transmitted to a digital-to-analog converter (DAC) 260 to convert to analog information. The converted analog information is transmitted to the audio output device 270 to output.

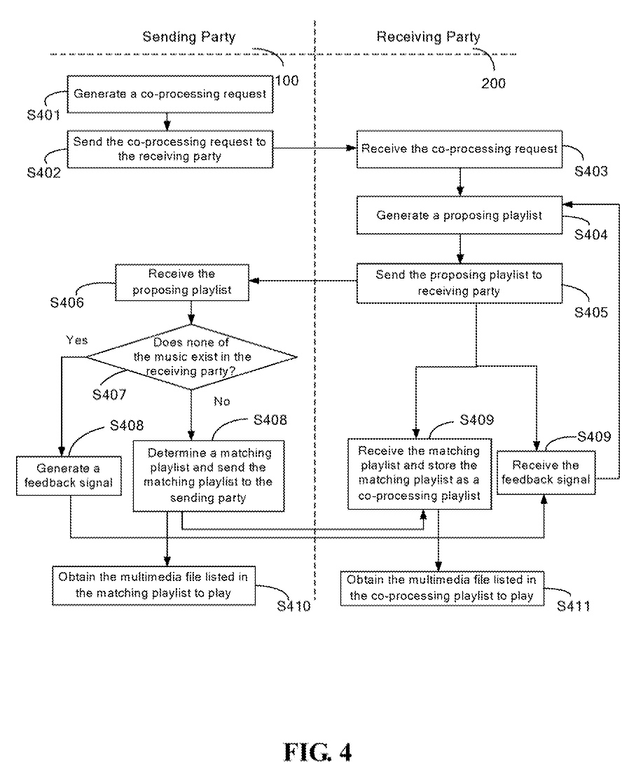

FIG. 4 is a flowchart of a multimedia file co-processing method of the present disclosure. In block S401, the sending party 100 generates a co-processing request according to operations of the user via an input unit 140;

In block S402, the sending party sends the co-processing request to the receiving party 200.

In block S403, the receiving party 100 receives the co-processing request.

In block S404, the receiving party generates the proposing playlist according to the determined multimedia files. The detailed description of generating the proposing playlist is described with respect to FIG. 2.

In block S405, the receiving party 200 sending the proposing playlist to the sending party 100 via the communication module 210 of the receiving party 200.

In block S406, the sending party 100 receives the proposing playlist transmitted from the receiving party 200.

In block S407, the sending party 100 determines if there are none of the multimedia files listed in the proposing playlist exists in the sending party 100.

In block S408, if none of the multimedia files listed in the proposing playlist exists in the sending party 100, the sending party 100 generates a feedback signal and send the feedback signal to the receiving party 200. If one or more multimedia files listed in the proposing playlist exist in the sending party 100, the sending party 100 generates the matching playlist and sends the matching playlist to the receiving party 200. The detailed description of generating the matching playlist is described with respect to FIG. 2.

In block S409, the receiving party 200 receives the feedback information from the sending party 100. If the feedback signal is received, the procedure goes to block S401. If the matching playlist is received, the receiving party stores the matching playlist as the co-processing playlist to the data storage 220 of the receiving party 200.

In block S410, the sending party 100 reads the multimedia files listed in the matching playlist from the data storage 120 of the sending party 100 to play.

In block S41 1, the receiving party 200 reads the multimedia files listed in the co-processing playlist from the data storage 220 of the receiving party 200 to play.

Although the present disclosure has been specifically described on the basis of a preferred embodiment, the present disclosure is not to be construed as being limited thereto. Various changes or modifications may be made to the present disclosure without departing from the scope and spirit of the present disclosure.

What is claimed is:

1. A mobile electronic system for sharing a multimedia playlist over a communication network to a sharing mobile electronic device, the system comprising:
a data storage that stores a plurality of multimedia files;
a co-processing request generating module configured for generating a co-processing request according to operations of the user via an input unit and sending the co-processing request to the sharing mobile electronic device;
a proposing playlist receiving module configured for receiving a proposing playlist listing multimedia files to be shared with the sharing mobile electronic device;
a co-processing playlist generating module configured for determining if one or more multimedia files listed in the proposing playlist exist in the data storage, and
generating a matching playlist according to the determined multimedia files;
an information sending module configured for sending the matching playlist to the sharing mobile electronic device; and
a play controlling module configured for playing the multimedia files listed in the matching playlist from the data storage.

2. The system as described in claim 1, wherein the co-processing playlist generating module is further configured for generating a feedback signal if none of the multimedia files listed in the proposing playlist exist in the data storage.

3. A mobile electronic system for receiving a multimedia playlist over a communication network from a sharing mobile electronic device, the system comprising:
a data storage that stores a plurality of multimedia files;
a proposing playlist determining module configured for receiving a co-processing request transmitted from the sharing mobile electronic device, selecting one or more multimedia files from the plurality of multimedia files according to a predetermined selection, generating a proposed playlist according to the selected multimedia files;
an information sending module configured for sending the proposed playlist to the sharing mobile electronic device;
a feedback information receiving module configured for receiving a matching playlist transmitted from the sharing mobile electronic device and saving the matching playlist as a co-processing playlist; and
a play controlling module configured for playing multimedia files listed in the co-processing playlist from the data storage.

4. The system as described in claim 3, wherein the feedback information receiving module is further configured for receiving a feedback signal and notifying the co-process request generating module to generate a new proposing playlist when the feedback signal is received.

5. A multimedia file co-processing method for a sending mobile electronic device adapted to communicate with a receiving mobile electronic device over a communication network, the method comprising:
(a) generating a co-processing request according to operations of a user;
(b) sending the co-processing request to the receiving mobile electronic device;
(c) receiving the co-processing request transmitted from the sending mobile electronic device;
(d) selecting multimedia files to be played synchronously between the sending mobile electronic device and the receiving mobile electronic device, and generating a proposing playlist according to the selected multimedia files;
(e) sending the proposing playlist to the receiving mobile electronic device
(f) receiving the proposing playlist from the receiving mobile electronic device;
(g) determining if the multimedia files listed in the proposing playlist exist in the sending mobile electronic device;
(h) generating a matching playlist according to determined multimedia files upon the condition that multimedia files listed in the proposing playlist exist in the sending mobile electronic device;
(i) sending the matching playlist to the receiving mobile electronic device
(j) receiving the matching playlist transmitted from the sending mobile electronic device and saving the matching playlist as a co-processing playlist;
(k) reading multimedia files listed in the co-processing playlist from the receiving mobile electronic device to play; and
(l) reading multimedia files listed in the matching playlist from the sending mobile electronic device to play.

6. The method as described in claim 5, further comprising:
sending a feedback signal to the receiving mobile electronic device upon the condition that none of multimedia files listed in the proposing playlist exist in the sending mobile electronic device;
receiving the feedback signal and going to block (d).
